(19) United States
(12) Patent Application Publication
(10) Pub. No.: US 2018/0018863 A1
(43) Pub. Date: Jan. 18, 2018

(54) PORTABLE PHONE ACTIVATED VIDEO CAMERA WITH PHONE LOCATION TRACKING

(71) Applicant: MUHAMMAD AL-AMIN, Richardson, TX (US)

(72) Inventor: MUHAMMAD AL-AMIN, Richardson, TX (US)

(21) Appl. No.: 15/547,130

(22) PCT Filed: Jan. 28, 2016
(86) PCT No.: PCT/US16/15459

§ 371 Date: Jul. 28, 2017

Related U.S. Application Data
(60) Provisional application No. 62/108,891, filed on Jan. 28, 2015.
(60) Provisional application No. 62/138,682, filed on Mar. 26, 2015.

(51) Int. Cl. G08B 13/196; H04L 29/12; G08B 13/24; H04N 7/18; H04N 5/77

(52) U.S. Cl. CPC G08B 13/19695; G08B 13/2494; H04N 7/18; G08B 13/19645; H04L 61/2596; H04N 5/77; H04L 61/6022

(57) ABSTRACT

A system for monitoring an area. The system has: (i) detecting apparatus for detecting a signal of a portable phone associated with a person in the area; (ii) capturing apparatus for capturing video in response to the detecting apparatus; (iii) communication apparatus for communicating the captured video to a monitoring location remote from the area; and monitoring apparatus at the monitoring location for determining whether the person is authorized to be in the area.

### TECHNICAL FIELD

The preferred embodiments relate to detection of persons in an unauthorized area and subsequent tracking of such persons.

### BACKGROUND ART

Theft at homes, stores, banks, is on the rise. The prior art often addresses such potential thefts using video or audiovisual surveillance. Such approaches often have proven inadequate to deter and ultimately capture the thief or other unauthorized person.

The present inventor has recognized in the above that various needs with certain unauthorized activities and detection thereof are not well-suited by the prior art. The preferred embodiments, therefore, seek to improve upon the prior art. For example, improvements of the preferred embodiments seek to lead to a much higher capture, arrest, and conviction rate, and likewise to deter or ultimately reduce theft, vandalism and burglaries. Such preferred embodiments are further explored below.

### DISCLOSURE OF INVENTION

In one preferred embodiment, there is a system for monitoring an area. The system comprises: (i) detecting apparatus for detecting a signal of a portable phone associated with a person in the area; (ii) capturing apparatus for capturing video in response to the detecting apparatus; (iii) communication apparatus for communicating the captured video to a monitoring location remote from the area; and monitoring apparatus at the monitoring location for determining whether the person is authorized to be in the area.

Other aspects are described and may be claimed. For example, in another preferred embodiment, in addition to the preceding, the system includes two-way IP-Based communication with a detected person at the monitored area. As another example, the preferred embodiment includes software with the ability to distinguish between bona fide MAC Addresses and hostile MAC Addresses by learning automatically and creating a “White list” of friendly MAC Addresses that are to be ignored. As another example, the preferred embodiment may include software to link a person on a video with the associated MAC address of that person on the live video and have the MAC address follow the person on the video. As a final example, the system may include software to allow the same antenna to provide Internet connectivity for an RCU as well as the MAC Address capture function.

### BRIEF DESCRIPTION OF DRAWINGS

The preferred embodiments are described in detail below by referring to the accompanying drawings:

FIG. 1 illustrates a diagrammatic view of various elements of the preferred embodiment in connection with detecting and tracing a person unauthorized to be within an area.

FIG. 2 illustrates a block diagram of a preferred embodiment Remote Control Unit, as introduced above in connection with FIG. 1.

FIG. 3 illustrates a block diagram of various preferred embodiment hardware and software.

FIG. 4 illustrates a preferred embodiment process flow.

FIG. 5 illustrates a preferred embodiment methodology of determining a Phone Service Provider and additional information (e.g., address, phone number) of a person detected in the monitored area.

FIG. 6 illustrates a diagrammatic view of various elements of the preferred embodiment in connection with detecting and tracing a person unauthorized to be within an area at a home.

FIG. 7 illustrates a block diagram of an alternative preferred embodiment Remote Control Unit, as introduced above in connection with FIG. 5.

FIG. 8 illustrates an alternative preferred embodiment process flow.

FIG. 9 illustrates a preferred embodiment methodology of determining a Phone Service Provider and additional information (e.g., address, phone number) of a person detected in the monitored area.

FIG. 10 illustrates a preferred embodiment methodology of Video Sample in a store.

FIG. 11 illustrates a preferred embodiment Store Network Diagram.

FIG. 12 illustrates a preferred embodiment of the Store system application setup.

FIG. 13 illustrates a preferred embodiment Home Network Diagram.

FIG. 14 illustrates a preferred embodiment of the Home system application setup.

### DESCRIPTION OF EMBODIMENTS

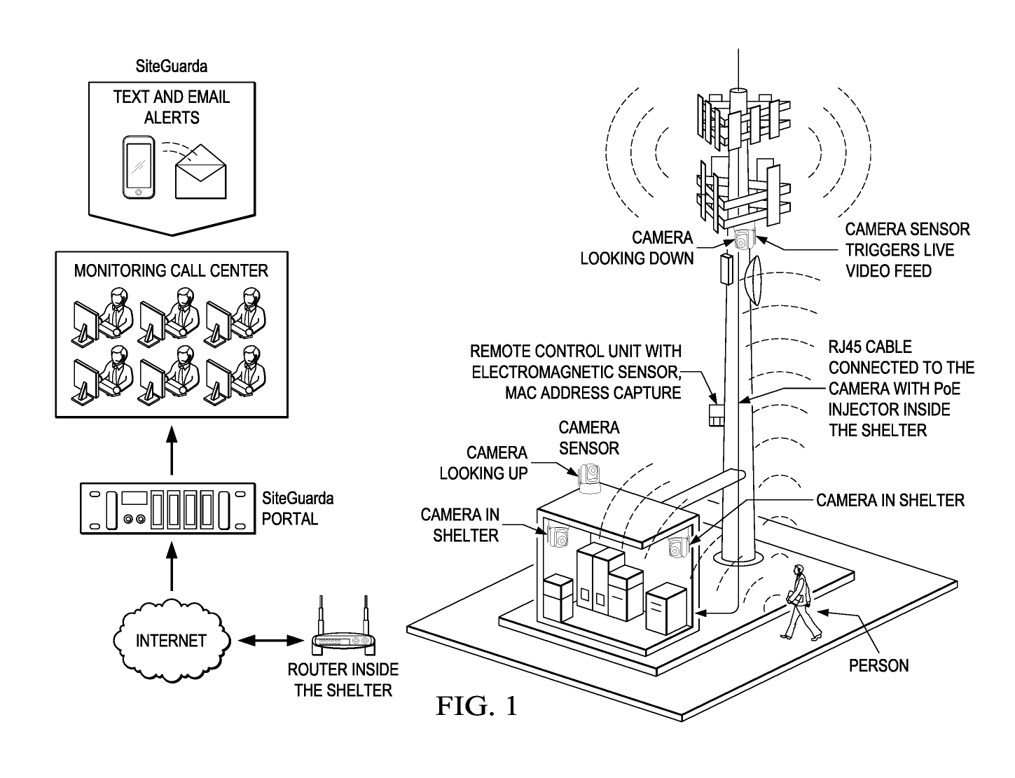

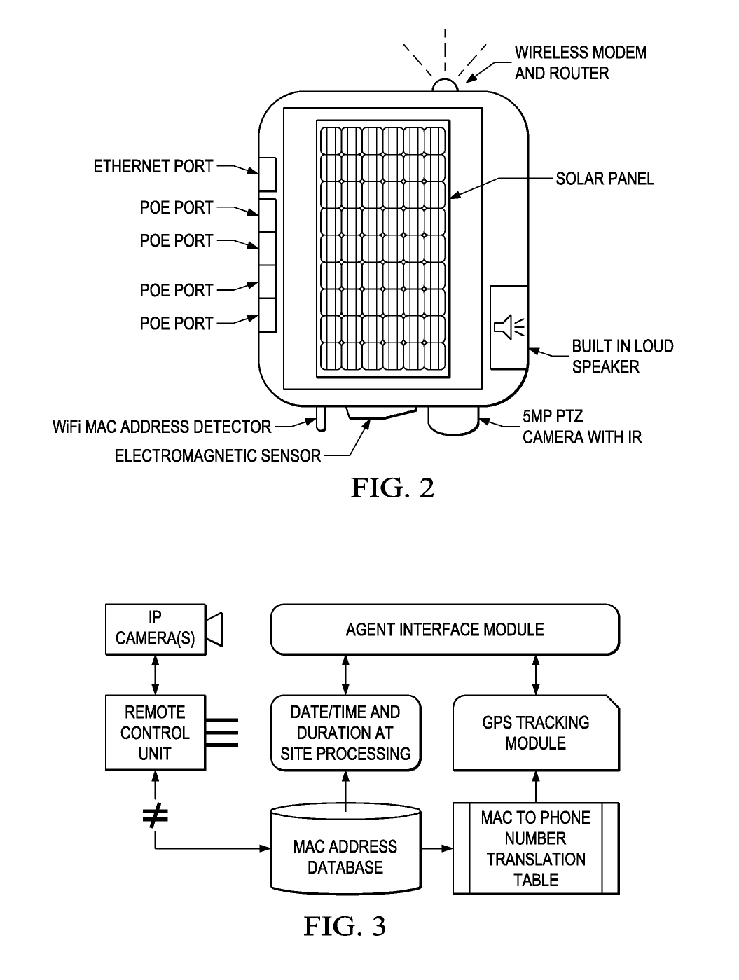

FIG. 1 illustrates a diagrammatic view of various elements of the preferred embodiment system 10 in connection with detecting and tracing a person unauthorized to be within an area. In general, FIG. 1 illustrates an AREA that is monitored according to preferred embodiments, in connection with various hardware, including: (i) one or more cameras, preferably one or more having motion-detecting technology, and located in various areas and with positioning to provide adequate surveillance of the AREA; (ii) a Monitoring Call Center (optionally including one or more personnel); (iii) a Remote Control Unit (“RCU”), shown in more detail in FIG. 2, which preferably includes one or more of a camera, a wireless detector, an electromagnetic sensor, and a loud speaker; and (iv) a communications network between a camera (and/or the RCU) and the Center, including, for example, a router, the Internet or some other network, and a portal medium that may be effect various process steps, such as via an appropriate amount of hardware and/or software, as may be selected and combined by one skilled in the art.

FIG. 2 illustrates a block diagram of a preferred embodiment RCU, as introduced above in connection with FIG. 1. The RCU includes circuitry for wireless communication, including a modem and potentially a router, so as to communicate with other wireless devices (e.g., via data packets and a protocol, such as the well-known Internet protocol (IP)). For example, in FIG. 1, the RCU may communicate wirelessly with any other separate camera, as well as with the communications network. The RCU further includes a power source, which preferably is a solar panel, so as to provide power for the various circuits and functionality while requiring minimum maintenance and avoiding the need for locally-connected power or batteries. The RCU further includes a camera, preferably of a resolution of at least 5 megapixels (MP), and has remote control for adjusting the view, including for example PTZ (pan-tilt-zoom) control. The camera includes an infrared (IR) sensor for lux technology, along with standard pixel technology, either of which is capable of capturing images as well as detecting movement. Still further, the RCU includes a number of Ethernet ports, some of which are preferably power over Ethernet (POE), for purposes of wired connections, if desired, to other components. The RCU also includes an electromagnetic sensor, which is operable to detect if something within electromagnetic radiation wave length of 9.4 um, (which is for humans and animals). Still further, the RCU includes what is shown as a WiFi MAC Address Detector, which is circuitry operable to detect a wireless signal from a portable device in the AREA. This Detector, therefore, may be equipped to detect one or more types of wireless signals. In a preferred embodiment, one such wireless signal is a transmission of a MAC address, that is, the Detector may be embodied as a Wireless Access Point (WAP) in the AREA, that is therefore responsive to a MAC-emitting device entering the AREA. More specifically, to capture a MAC address, an IEEE 802.11 protocol (Wi-Fi) is used. Any device that emits Wi-Fi may be detected by the preferred embodiments in that Wi-Fi devices periodically send a protocol related data header called a Management Frame, and relatedly there is a Beacon Frame that contains MAC, Timestamp, SSID and Signal Frequency Information. The preferred embodiments decode this Beacon Frame and extract the device MAC address. Also in a preferred embodiment, another such wireless signal is a Bluetooth signal, which likewise may be detected by the preferred embodiments. Lastly, the RCU includes a loud speaker, so as to emit sounds based on communications delivered to the RCU, via either its wireless modem or its Ethernet ports. Optionally, related to the loud speaker also may be a microphone, so that a detected person in the AREA can respond, as further detailed below.

Returning to FIG. 1, according to preferred embodiments, the AREA, which may include various additional related buildings, shelter, equipment, and the like, is monitored by the RCU and apparatus communicating with the RCU, so as to detect any person in the AREA and ultimately to determine whether the person is authorized (e.g., worker, employee, contractor) or unauthorized (e.g., thief, vandal), to be in the AREA. The radius of detection will depend on the type of detection apparatus involved. According to a preferred embodiment, the AREA detection is achieved by various apparatus so as to detect any person in the AREA. Preferably, such detection may be achieved by one or more of three processes, including: (1) motion detection via any of the cameras; (2) electromagnetic wave detection by the Remote Control Unit; and (3) WiFi MAC address detection, also by the Remote Control Unit, in response to receiving a signal(s) from a portable (e.g., cellular) phone carried by any person in the vicinity, so the detection radius is equal to or less than the transmission distance of the portable phone. By way of example, therefore, FIG. 1 illustrates a PERSON in the AREA, and the preferred embodiments operate to detect that PERSON. For example, if the person moves and is within the field of view of a camera, its related motion detector, or technology detecting same from the image capture, will detect such movement and assert a DETECT signal, indicating that a person may be in the AREA. As another example, if the person moves within the range (e.g., 30 feet) of the RCU electromagnetic sensor, and that person's transmits electromagnetic waves (all humans generate electromagnetic radiation wave length of 9.4 um), then the sensor will likewise assert the DETECT signal. As a final example, if the person is carrying a portable phone that is emitting either a MAC address or a Bluetooth signal, then the RCU Detector is operable to detect either or both the MAC address and the Bluetooth ID of the detected portable phone. As detailed below, once the PERSON's presence is detected by any one or more of these processes, various of the communications network operate to record and communicate information with respect to the detection and toward the goal of determining whether the person is authorized to be in the AREA, and if determining the PERSON is not so authorized, to take additional action toward identifying and/or apprehending the PERSON.

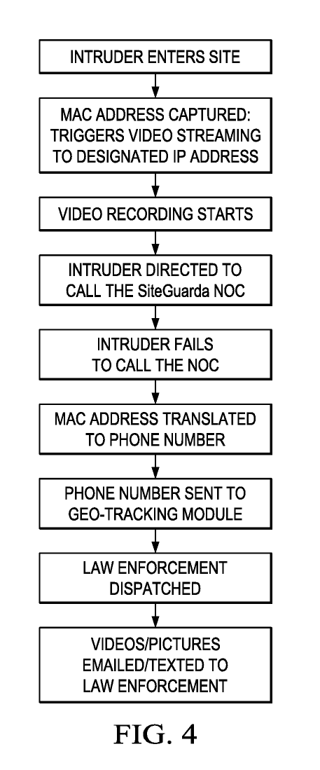

FIG. 3 illustrates a block diagram of various preferred embodiment hardware and software, some of which is introduced above, and that is further described now with FIG. 4, which illustrates a preferred embodiment process flow that is also appreciated in connection with FIG. 1. In FIG. 4, once a PERSON enters the AREA, the PERSON is detected (and the corresponding DETECT signal is asserted), which by way of example in FIG. 4 occurs by detecting a beacon or other transmitted signal (e.g., Bluetooth) associated with the PERSON's portable telephone; recall from above, however, motion or electromagnetic radiation also may provide the detection. In the example, however, the repeated transmission of the phone's Media Access Control (MAC) address may be detected by the RCU Detector. In response to the detection, as indicated by the asserted DETECT signal, the video from one or more of the FIG. 1 cameras are recorded, where such camera could be awakened from a (power savings) sleep mode, if appropriate, or if such cameras are already enabled, recording may commence. Note in one preferred embodiment such detection may be effected by having a Wireless Access Point (WAP) in the AREA that is responsive to a MAC-emitting device entering the AREA, so in the present example the WAP detects the newly-emitted MAC address from the PERSON's portable phone and, in response, the WAP, or circuitry associated with it, enables one more cameras in the AREA. Note in another preferred embodiment such detection may be effected by one or more motion-detecting sensors, or motion-detecting technology based on camera image captures, which detect such motion and cause the enabling/recording from one more cameras in response, or still further the person may be detected due to electromagnetic radiation created by his/her presence in the AREA. In any event, the DETECT signal enables one more cameras to collect video (and potentially corresponding audio) and stream it via the communications network, such as to the Internet Protocol (IP) address of the Monitoring Call Center, while such video information is also preferably recorded, either locally at storage in the AREA or remotely at the Monitoring Call Center. In addition, while not shown in FIG. 4, FIG. 1 also indicates in its top left corner that in response to the DETECT signal (i.e., to detecting a person in the AREA), the preferred embodiment also preferably transmits a separate communication(s), such as by way of SMS, text, or email, alerting the Monitoring Call Center (or other person) that a DETECT signal has been asserted based on activity in the AREA.

Continuing in FIG. 4, in response to having detected the PERSON in the AREA, the preferred embodiment directs the PERSON to call a respondent, such as at a Network Operations Center (NOC) that may be located at the Monitoring Call Center. For example, once the PERSON is detected, an Agent at the NOC attempts to communicate with the PERSON via the RCU loud speaker, where this may be achieved by an IP communication from the NOC to the RCU. The communication may be prerecorded or spoken by the Agent, asking the PERSON to call the Agent (or speak to the Agent via the RCU microphone, if so equipped).

Continuing in FIG. 4, either the NOC or Monitoring Call Center determines whether the detected PERSON has responded, for example within a predetermined period of time, to the instructions to call the NOC. If such a response is received by the NOC, then an Agent may communicate with the PERSON to determine if the PERSON has proper authority to be within the AREA. If such authority is confirmed, the preferred embodiment may stop recording and no longer concern itself with the presence of the

PERSON. Note also during this time that the NOC or Monitoring Call Center preferably has access to the ongoing video (or other image) capture so as to secondarily evaluate the PERSON's behavior during this time. Thus, if the PERSON's responses or video-observed activities are suspicious or otherwise unacceptable, or if the PERSON has not responded within the above-mentioned predetermined period of time, the PERSON is deemed or tagged as an unauthorized entrant in the AREA and the preferred embodiment takes one or more additional steps to identifying, tracking, and apprehending the PERSON.

In one preferred embodiment in connection with a PERSON having been found to be an unauthorized entrant, the preferred embodiment communicates immediately with law enforcement that may be therefore dispatched to attempt to apprehend the PERSON. While the law enforcement is being contacted and/or is in route to the AEEA, and if the PERSON leaves the AREA before law enforcement arrives, he or she may be tracked via a Global Positioning Satellite (GPS) tracking module, which receives GPS information from the PERSON's portable device and informs law enforcement of that information, thereby identifying the whereabouts of the PERSON, as further detailed later. In addition, a preferred embodiment preferably translates information from the PERSON's phone address to additional information for identifying the PERSON. For example, the preferred embodiment may translate the PERSON's MAC address to a phone number, which phone number may be used in various databases to track the person. Further in this regard, the translated phone address may be reported to appropriate law enforcement, for further action, such as dispatch to the AREA and other locations so as to investigate, question, and potentially detain and arrest the PERSON. Indeed, such communication also may be automated with hardware/software so as to expedite the request and minimize the introduction of human error into the communication. Note also that any other information theretofore captured about the PERSON, including the video (and optional audio) previously recorded upon detecting the PERSON's presence in the AREA, also may be given to law enforcement.

In another preferred embodiment in connection with a PERSON having been found to be an unauthorized entrant, the preferred embodiment implements additional processes so as to geo-track the PERSON, that is, to track the PERSON's geographical location once he or she leaves the AREA or at least the portions of the AREA that are viewable by the AREA camera(s). In one preferred embodiment, such geographical tracking may be accomplished in connection with a GPS feature on the PERSON's portable phone. For example, in one preferred embodiment, in connection with detecting the PERSON's presence in the AREA as described above, access to the PERSON's phone may be effected so as to install a program on such a phone so as to enable the phone to report its GPS location, that is, the preferred embodiment contemplate temporarily pushing, for example, code to the phone which may be disabled or removed if the PERSON is determined to be authorized in the AREA. To the contrary, if the PERSON is deemed unauthorized as described above, the GPS reporting feature is left enabled by the preferred embodiment, so as to allow ongoing tracking of the PERSON, such as by the NOC, the Monitoring Call Center, and/or appropriate law enforcement. Note that the addition of such programming in this regard may be with or without some cooperation of the PERSON, depending on various considerations and with some or no understanding of the PERSON's cooperation in this regard; hence, one skilled in the art will develop adequate measures to work within the parameters of the phone make, model, and software so as to achieve such programming.

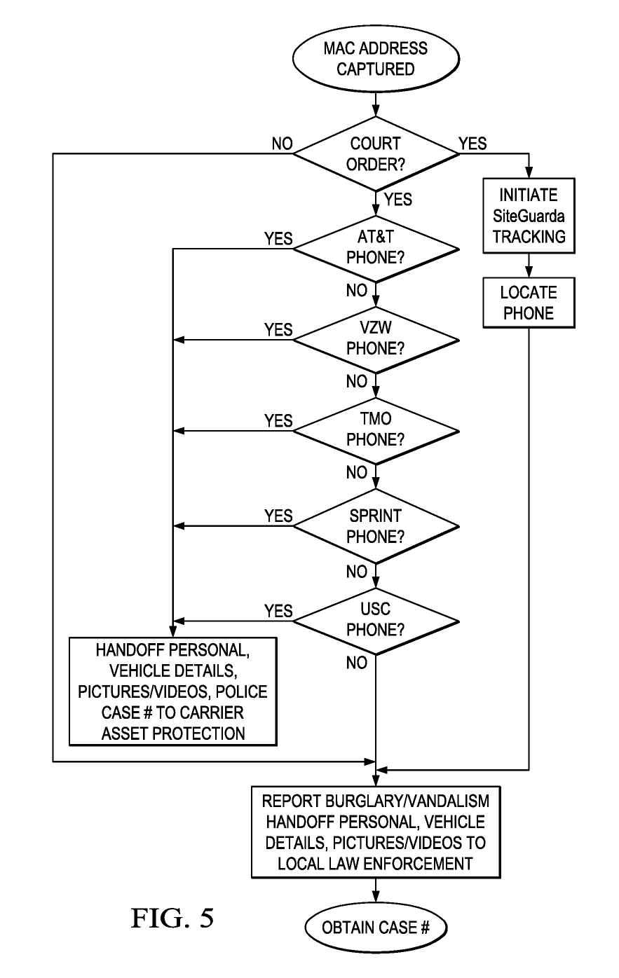

FIG. 5 illustrates a flow chart of additional preferred embodiment processes that may be implemented so as to translate the detected MAC address to a phone number (and/or account address), as introduced above. Specifically, once the PERSON's MAC address is captured, a court order can be sought so as to provide proper legal authority to the proper cell phone carrier for the phone carried by the PERSON. FIG. 5 generally indicates, therefore, a question step as to whether a court order has yet been received. If not, then information currently known may be reported to local law enforcement. Once a court order is obtained, however, the left of FIG. 5 indicates that various cell phone carriers may be contacted so as to obtain additional information (e.g., formerly private) associated with the detected MAC address, and that additional information is also provided to law enforcement. If no such phone carrier is identified, then the otherwise known and captured information still may be reported to law enforcement, so as to assist it in investigating the unauthorized entry of the PERSON in the AREA and any related activity during that entry.

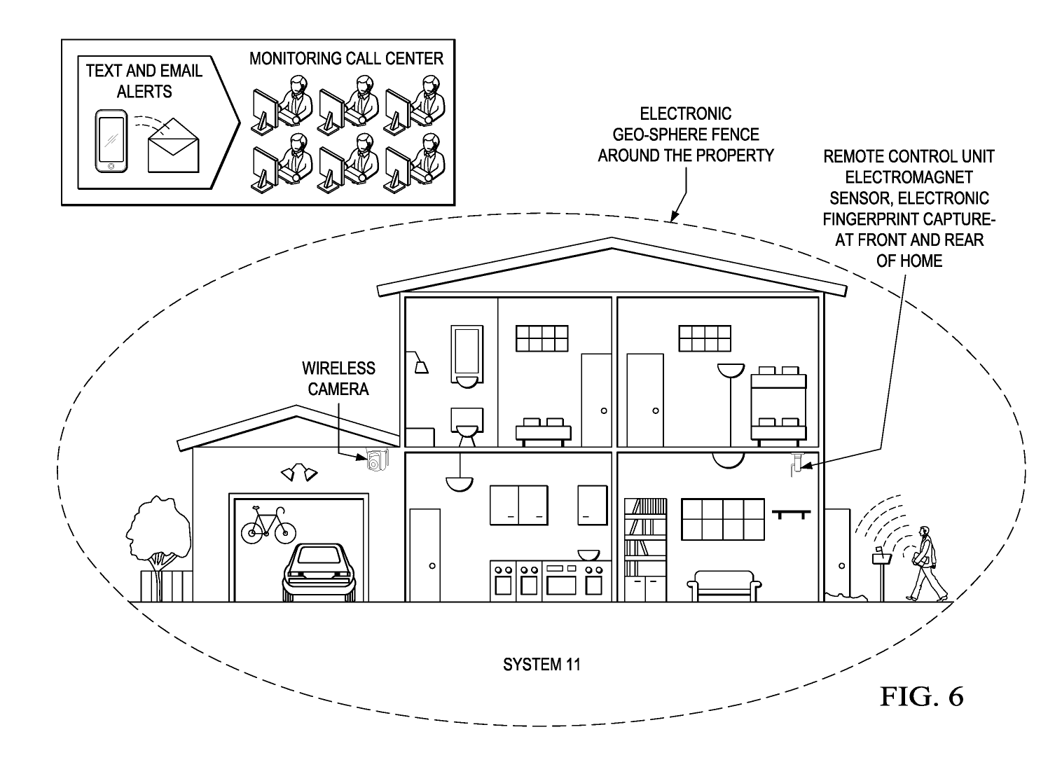

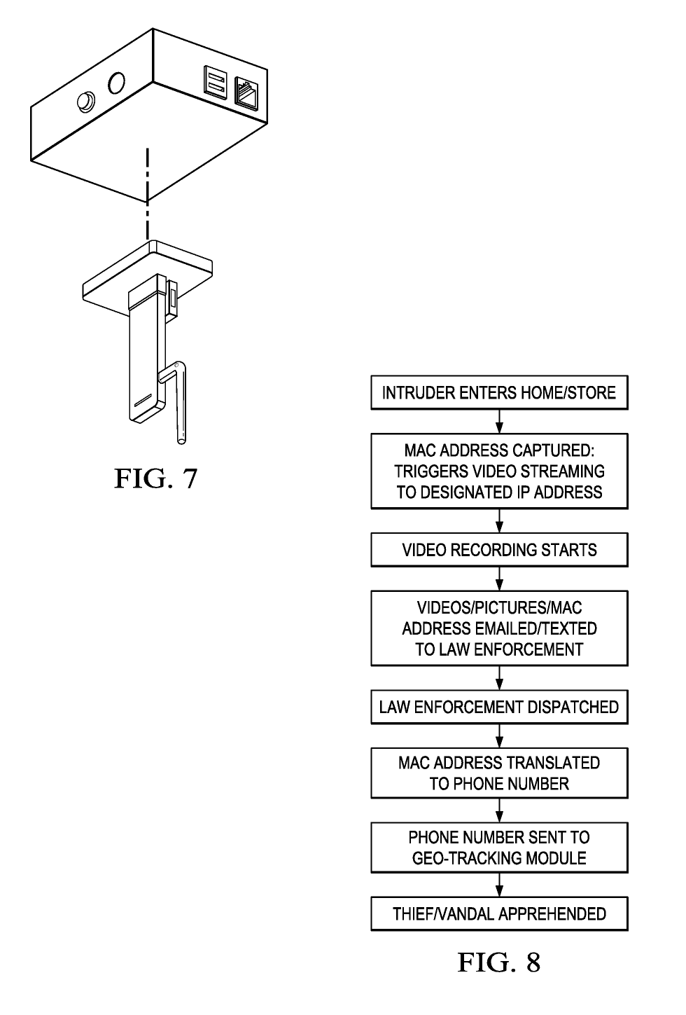

FIG. 6 illustrates a diagrammatic view of various elements of an alternative preferred embodiment System 11 in connection with detecting and tracing a person unauthorized to be within a home area, where the area is shown in FIG. 6 as an electronic Geo-Sphere Fence. In general, FIG. 6 illustrates the Geo-Sphere Fence that is monitored according to preferred embodiments, in connection with various hardware, including: (i) one or more cameras, preferably one or more having motion-detecting and person-detecting technology, and located in various areas and with positioning to provide adequate surveillance of the Geo-Sphere Fence; (ii) a Monitoring Call Center (optionally including one or more personnel); (iii) a Remote Control Unit (“RCU”), shown in more detail in FIG. 7, which preferably includes one or more of a camera, a wireless detector, an electromagnetic sensor, and a loud speaker; and (iv) a communications network between a camera (and/or the RCU) and the Center, including, for example, a router, the Internet or some other network, and a portal medium that may effect various process steps, such as via an appropriate amount of hardware and/or software, as may be selected and combined by one skilled in the art.

FIG. 7 illustrates a perspective view of a preferred embodiment RCU, as introduced above in connection with FIG. 6. The RCU includes circuitry for wireless communication, including a modem, potentially a router, and an antenna, so as to communicate with other wireless devices (e.g., via data packets and a protocol, such as the well-known Internet protocol (IP)). For example, in FIG. 6, the RCU may communicate wirelessly with any other separate camera, as well as with the communications network. As such, via a communications network, or other interface, software and a graphical user interface is preferably associated with the RCU, so that a local or remote user can interact with data captured and/or stored by the RCU. The RCU further includes an AC/DC/Battery power input so as to provide power for the various circuits and functionality while requiring minimum maintenance Still further, the RCU includes an Ethernet port for hard-wired Internet connection instead of wireless connectivity. The RCU also includes an electromagnetic sensor, which is operable to detect if something within electromagnetic radiation wave length of 9.4 um, (which is for humans and animals). Still further, the RCU includes a WiFi MAC Address Detector, which is circuitry operable to detect a wireless signal from a portable device in the Geo-Sphere Fence. This Detector, therefore, may be equipped to detect one or more types of wireless signals. In a preferred embodiment, one such wireless signal is a transmission of a MAC address, that is, the Detector may be embodied as a Wireless Access Point (WAP) in the Geo-Sphere Fence, that is therefore responsive to a MAC-emitting device entering the Geo-Sphere Fence, as would occur if a person enters the Geo-Sphere Fence with an operable cell phone that communicates its MAC address. More specifically, to capture a MAC address, an IEEE 802.11 protocol (Wi-Fi) is used. Any device that emits Wi-Fi may be detected by the preferred embodiments in that Wi-Fi devices periodically send a protocol related data header called a Management Frame, and relatedly there is a Beacon Frame that contains MAC, Timestamp, SSID and Signal Frequency Information. The preferred embodiments decode this Beacon Frame and extract the device MAC address. Also in a preferred embodiment, another such wireless signal is a Bluetooth signal, which likewise may be detected by the preferred embodiments. Lastly, the RCU includes a loud speaker, so as to emit sounds based on communications delivered to the RCU, via either its wireless modem or its Ethernet port(s). Optionally, related to the loud speaker also may be a microphone, so that a detected person in the Geo-Sphere Fence can respond, as further detailed below.

Returning to FIG. 6, according to preferred embodiments, the Geo-Sphere Fence, which may include various additional related buildings, shelter, equipment, and the like, is monitored by the RCU and apparatus communicating with the RCU, so as to detect any person in the Geo-Sphere Fence and ultimately to determine whether the person is authorized (e.g., home-owner, family member, guests) or unauthorized (e.g., thief, vandal), to be in the Geo-Sphere Fence. In a preferred embodiment, the radius of MAC Address detection, as performed by the RCU, will adjustable by the RCU owner/user. Specifically, the user has access to a hardware or software (e.g., graphical interface) adjustment or controller, and in response circuitry operates according the user control and per the following formula to set the radius of detection, also called the radius of the Geo-Sphere Fence, around the home, store, or other building with which the RCU is located, in response to the user's adjustment.

For reference, a Distance (d) is defined as the distance between a transmitter and a receiver (as measured, for example, as between the antennas). Further, the signal strength between the transmitter and the receiver, that is, along the distance d, reduces with the distance d. Further, the distance d may be adjusted as between a Receiver (e.g., the preferred embodiment RCU) and a transmitter (e.g., the wireless device carried by a person), that is, the radius of the Geo Sphere Fence in FIG. 6 is defined about the RCU for the distance d. Moreover, the signal strength, and its associated loss, is determinable according to the following formula:

FSLP(dB)=20 log₁₀(d)+20 log₁₀(f)+32.45

where,
f=2.4 Ghz,
dB=signal strength captured from nearby cell phone;
d is the distance between cell phone and preferred embodiment MAC Address detector (i.e., of the RCU).

More specifically, the 802.11 standard defines various types of communication frame between WNICs (stations) and Access Points. One of the types of data frame is called the Management Frame, which is responsible for managing and controlling the wireless network link. The Management Frame has a few sub categories or types. One of the sub types is called the Probe Request frame. A station usually sends a Probe Request frame to find the nearest Access Point(s). The Probe request has a field containing the RF signal power at the Antenna. This field value is represented as an 8-bit single signed value. This binary value is later transformed into −dB or RSSI format.

According to a preferred embodiment, the Geo-Sphere Fence detection is achieved by various apparatus so as to detect any person in the Geo-Sphere Fence. Preferably, such detection may be achieved by one or more of three processes, including: (1) motion detection via any of the cameras; (2) electromagnetic wave detection by the sensor (e.g., passive infrared) of the Remote Control Unit; and (3) WiFi MAC address detection, also by the Remote Control Unit, in response to receiving a signal(s) from a portable (e.g., cellular) phone carried by any person in the vicinity, so the detection radius is equal to or less than the transmission distance of the portable phone. By way of example, therefore, FIG. 6 illustrates a person in the Geo-Sphere Fence, and the preferred embodiments operate to detect that person. For example, if the person moves and is within the field of view of a camera, its related motion detector, or technology detecting same from the image capture, will detect such movement and assert a DETECT signal, indicating that a person may be in the Geo-Sphere Fence. As another example, if the person moves within the range (e.g., 30 feet) of the RCU electromagnetic sensor, and that person transmits electromagnetic waves (all humans generate electromagnetic radiation wave length of 9.4 um), then the sensor will likewise assert the DETECT signal. As a final example, if the person is carrying a portable phone that is emitting either a MAC address or a Bluetooth signal, then the RCU Detector is operable to detect either or both the MAC address and the Bluetooth ID of the detected portable phone. As detailed below, once the person's presence is detected by any one or more of these processes, various apparatus of the communications network operate to record and communicate information with respect to the detection and toward the goal of determining whether the person is authorized to be in the AREA, and if determining the PERSON is not so authorized, to take additional action toward identifying and/or apprehending the PERSON.

FIG. 8 illustrates a preferred embodiment process flow that is also appreciated in connection with FIGS. 3 and 6. In FIG. 8, once a person enters the Geo-Sphere Fence, the person is detected (and the corresponding DETECT signal is asserted), which by way of example in FIG. 8 occurs by detecting a beacon or other transmitted signal (e.g., Bluetooth) associated with the person's portable telephone; recall from above, however, motion or electromagnetic radiation also may provide the detection. In the example, however, the repeated transmission of the phone's Media Access Control (MAC) address may be detected by the RCU Detector. In response to the detection, as indicated by the asserted DETECT signal, the video from one or more of the FIG. 6 cameras are recorded, where such camera could be awakened from a (power savings) sleep mode, if appropriate, or if such cameras are already enabled, recording may commence. Note in one preferred embodiment such detection may be effected by having a Wireless Access Point (WAP) in the Geo-Sphere Fence that is responsive to a MAC-emitting device entering the Geo-Sphere Fence, so in the present example the WAP detects the newly-emitted MAC address from the person's portable phone and, in response, the WAP, or circuitry associated with it, enables one or more cameras in the Geo-Sphere Fence. Note in another preferred embodiment such detection may be effected by one or more motion-detecting sensors, or motion-detecting technology based on camera image captures, which detect such motion and cause the enabling/recording from one or more cameras in response, or still further the person may be detected due to electromagnetic radiation created by his/her presence in the Geo-Sphere Fence. In any event, the DETECT signal enables one or more cameras to collect video (and potentially corresponding audio) and stream it via the communications network, such as to the Internet Protocol (IP) address of the Monitoring Call Center, while such video information is also preferably recorded, either locally at storage in the Geo-Sphere Fence or remotely at the Monitoring Call Center. In addition, while not shown in FIG. 8, FIG. 6 also indicates in its top left corner that in response to the DETECT signal (i.e., to detecting a person in the Geo-Sphere Fence), the preferred embodiment also preferably transmits a separate communication(s), such as by way of SMS, text, or email, alerting the Monitoring Call Center (or other person) that a DETECT signal has been asserted based on activity in the AREA.

Continuing in FIG. 8, in response to having detected the person in the Geo-Sphere Fence, the preferred embodiment directs the person to call a respondent, such as at a Network Operations Center (NOC) that may be located at the Monitoring Call Center. For example, once the person is detected, an Agent at the NOC attempts to communicate with the person via the RCU loud speaker, where this may be achieved by an IP communication from the NOC to the RCU. The communication may be prerecorded or spoken by the Agent, asking the PERSON to call the Agent (or speak to the Agent via the RCU microphone, if so equipped).

Further in the preferred embodiment, either the NOC or Monitoring Call Center determines whether the detected person has responded, for example within a predetermined period of time, to the instructions to call the NOC. If such a response is received by the NOC, then an Agent may communicate with the person to determine if the person has proper authority to be within the Geo-Sphere Fence. If such authority is confirmed, the preferred embodiment may stop recording and no longer concern itself with the presence of the person. Note also during this time that the NOC or Monitoring Call Center preferably has access to the ongoing video (or other image) capture so as to secondarily evaluate the person's behavior during this time. Thus, if the person's responses or video-observed activities are suspicious or otherwise unacceptable, or if the person has not responded within the above-mentioned predetermined period of time, the person is deemed or tagged as an unauthorized entrant in the Geo-Sphere Fence and the preferred embodiment takes one or more additional steps to identifying, tracking, and apprehending the person.

In one preferred embodiment in connection with a person having been found to be an unauthorized entrant, the preferred embodiment communicates immediately with law enforcement that may be therefore dispatched to attempt to apprehend the person. While the law enforcement is being contacted and/or is in route to the Geo-Sphere Fence, and if the person leaves the Geo-Sphere Fence before law enforcement arrives, he or she may be tracked via a Global Positioning Satellite (GPS) tracking module (see FIG. 7), which receives GPS information from the PERSON's portable device and informs law enforcement of that information, thereby identifying the whereabouts of the person, as further detailed later. In addition, a preferred embodiment preferably translates information from the person's phone address to additional information for identifying the person. For example, the preferred embodiment may translate the person's MAC address to a phone number, which phone number may be used in various databases to track the person. Further in this regard, the translated phone address may be reported to appropriate law enforcement, for further action, such as dispatch to the Geo-Sphere Fence and other locations so as to investigate, question, and potentially detain and arrest the PERSON. Indeed, such communication also may be automated with hardware/software so as to expedite the request and minimize the introduction of human error into the communication. Note also that any other information theretofore captured about the PERSON, including the video (and optional audio) previously recorded upon detecting the person's presence in the Geo-Sphere Fence, also may be given to law enforcement.

In another preferred embodiment in connection with a person having been found to be an unauthorized entrant, the preferred embodiment implements additional processes so as to geo-track the person, that is, to track the person's geographical location once he or she leaves the Geo-Sphere Fence or at least the portions of the Geo-Sphere Fence that are viewable by the Geo-Sphere Fence camera(s). In one preferred embodiment, such geographical tracking may be accomplished in connection with a GPS feature on the person's portable phone. For example, in one preferred embodiment, in connection with detecting the person's presence in the Geo-Sphere Fence as described above, access to the person's phone may be effected so as to install a program on such a phone so as to enable the phone to report its GPS location, that is, the preferred embodiment contemplates temporarily pushing, for example, code to the phone which may be disabled or removed if the person is determined to be authorized in the Geo-Sphere Fence. To the contrary, if the person is deemed unauthorized as described above, the GPS reporting feature is left enabled by the preferred embodiment, so as to allow ongoing tracking of the person, such as by the NOC, the Monitoring Call Center, and/or appropriate law enforcement. Note that the addition of such programming in this regard may be with or without some cooperation of the person, depending on various considerations and with some or no understanding of the person's cooperation in this regard; hence, one skilled in the art will develop adequate measures to work within the parameters of the phone make, model, and software so as to achieve such programming

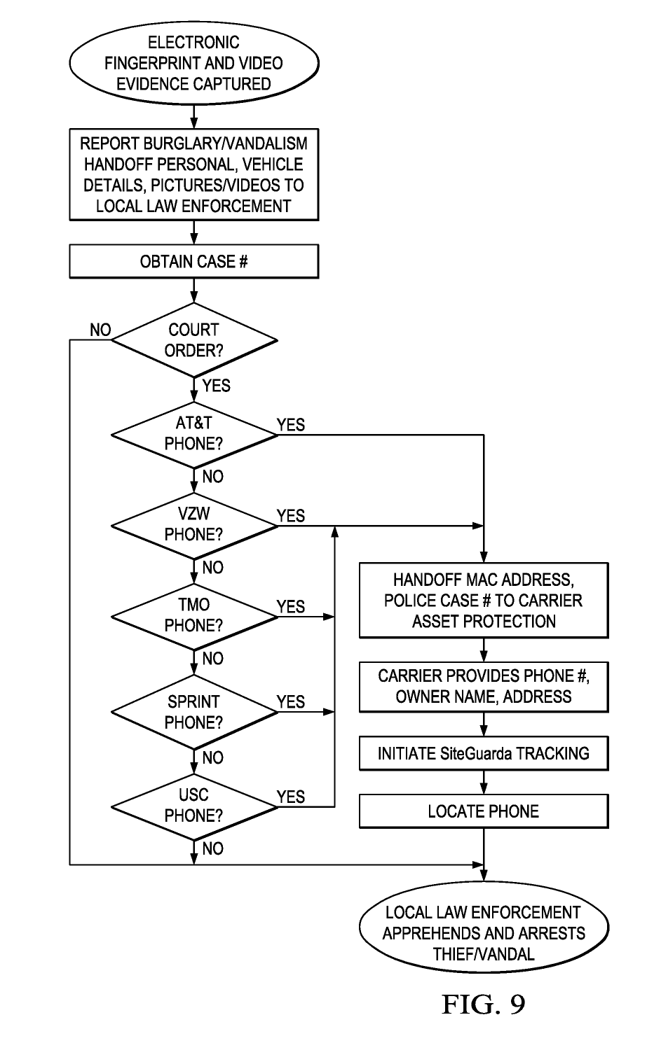

FIG. 9 illustrates a flow chart of additional preferred embodiment processes that may be implemented so as to translate the detected MAC address to a phone number (and/or account address), as introduced above. Specifically, once the person's MAC address is captured, a court order can be sought so as to provide proper legal authority to the proper cell phone carrier for the phone carried by the person. FIG. 9 generally indicates, therefore, a question step as to whether a court order has yet been received. If not, then information currently known may be reported to local law enforcement. Once a court order is obtained, however, the left of FIG. 9 indicates that various cell phone carriers may be contacted so as to obtain additional information (e.g., formerly private) associated with the detected MAC address, and that additional information is also provided to law enforcement. If no such phone carrier is identified, then the otherwise known and captured information still may be reported to law enforcement, so as to assist it in investigating the unauthorized entry of the person in the Geo-Sphere Fence and any related activity during that entry

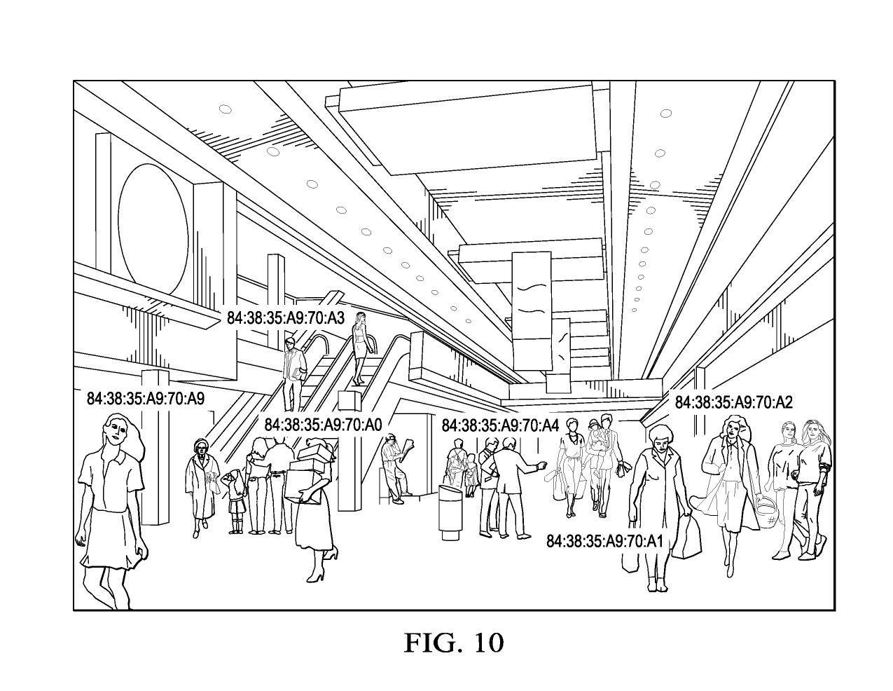

FIG. 10 depicts the ability of the system to capture and link the MAC address of each person present in an area, where the illustrated area is by way of example in a shopping environment. Thus, an RCU and other above-discussed apparatus may be installed in this area, with adjustments made in the distance d so that the persons illustrated are within that distance, that is, within a thereby defined Geo-Sphere Fence. As a result, the RCU is able to detect MAC addresses associated with each such person.

A preferred embodiment further includes additional aspects as may be appreciated from FIG. 10. Specifically, when the FIG. 6 system is implemented in certain embodiments, it may be expected that a number of familiar or otherwise non-intruding or permitted persons may be within the Geo-Sphere Fence. The preferred embodiment includes various methodologies, therefore, for distinguishing or learning such persons so as to distinguish them from others that may require additional analyses or indeed may be unwelcome or worthy of further investigation, suspicion, and reporting. In one preferred embodiment aspect, the video capture, as depicted in FIG. 10, associates one or more images of each person with their detected MAC address. So, by way of example in FIG. 10, the MAC address is displayed on top of each such person and moves and follows each person on the preferred embodiment video. A user may then consult the video, either real-time or later, and through an appropriate user (e.g., graphical) interface may indicate one or more persons as to be put on a “White list,” meaning a list, table or other storage of MAC addresses, optionally coupled with image data taken from the video, identifying each such person on that list as an acceptable person in the Geo-Sphere Fence. Note that other criteria may be implemented in the preferred embodiment for putting persons, and their MAC address and/or image data, on the White list. For example, if a person is frequently detected by the system as within the Geo-Sphere Fence, the user may be presented with an indication of such frequent person(s) and choose to add them to the White list; alternatively, the system may be configured to automatically add such persons. Moreover, the preferred embodiment includes a manner to allow the user to revisit the White list when desired, so as to change or remove any person, if desired, from the list. Given the White list, the preferred embodiment may future consult it when detecting a MAC address so as to respond accordingly, based on whether the detected person is or is not on that list. Additionally, with contemporary face recognition and other processes, the system may confirm that a person as detected not only is found on the White list by way of their MAC address, but also from face recognition (or other attribute) that was earlier associated with a MAC address, that is, by comparing a contemporary image of the person with the formerly-stored image of the person that was associated with the MAC address. In this manner, therefore, a person cannot steal someone's cell phone and then enter the Geo-Sphere Fence to evade detection, as the image of the cell phone thief will not match the earlier-stored image of the person formerly associated with the MAC address of the now-stolen phone. Thus, for persons confirmed on the White list, then the preferred embodiment thereafter can either ignore instances of detecting such a person or otherwise register that the person is an acceptable person to be there, so as to reduce or eliminate the need for investigation, interrogation, or the like. Note further that other variations may be applied, for example, based on the frequency of a person being detected, where more common frequencies may be an indicator to reduce the need to further investigate such a person.

Additional details with respect to tracking people based on Wi-Fi positioning for various embodiments are also contemplated. In general, such a preferred embodiment may be implemented with three modules: (i) a Wi-Fi positioning module; (ii) an image detection module; and (iii) a central data processing and decision support module. Items (i) and (ii) may be incorporated in or in lieu of the above-described RCU. Item (iii) may be located in part or in whole either at the location being monitored (e.g., part of a Geo-Sphere Fence) or remotely (e.g., part of a monitoring call center). In any event, this preferred embodiment system is preferably operated in conjunction with areas where larger number of persons are anticipated, some of whom may be authorized and some of whom may not. With the increase in population in such an area, a preferred embodiment contemplates additional aspects, as identifying unauthorized persons among authorized ones adds additional considerations and complexity. In all event, items (i) through (iii) are further discussed below.

Item (i), the Wi-Fi positioning module is operable and responsible for capturing an estimated position of a Wi-Fi device. Preferably this module includes a minimum of three Wi-Fi P positioning units to be set up around the location where tracking will be implemented. During the initialization phase, each such module unit recognizes the surrounding area as a digital Radio Map, by translating the intensity of the received signal strength at the respective unit receiver antenna. Once the Radio Map has been generated, the module unit is ready and will go to an online mode, that is, operable to communicate to other devices as part of the surveillance and detection functionality. In the online mode, the received signal strength and MAC address detected in each module unit are transmitted to the (iii) central data processing unit to locate the final position of a Wi-Fi device for which signals were received by the module unit.

Item (ii), the image detection module is operable to identify a person's presence in an image. For better accuracy, the image detection module captures at least a images of the place where the person(s) will be detected. The image is preferably captured in such a way that a few images are captured without any people, while additional images are captured with people present. However the system can work in default configuration and can improve its accuracy incrementally.

Item (iii), the central data processing and decision support module receives incoming data from item (i) the Wi-Fi Positioning module. Once the data processing unit receives enough data from the Wi-Fi positioning modules, it starts identifying respective location of persons captured in the images. In the next phase it requests a video frame from input live camera stream and identifies the segment of the image where the person is located. It also finds the actual distance between the camera and person based on camera focal length and person height. Subsequently, the system calculates the estimated distance from a Wi-Fi positioning module to user using the intensity of the signal. Now the system matches the estimated distance and actual distance to mark the user position with a MAC address in the output live camera video stream, as depicted in FIG. 10. If the difference between actual and estimated distance is too big then the system drops this calculation and waits for new data coming from Wi-Fi Positioning module. In all events, therefore, image data associated with a given person is therefore ultimately associated also with a corresponding MAC address, thereby providing an output by which both the person and their respective MAC address are readily depicted to a person viewing the output.

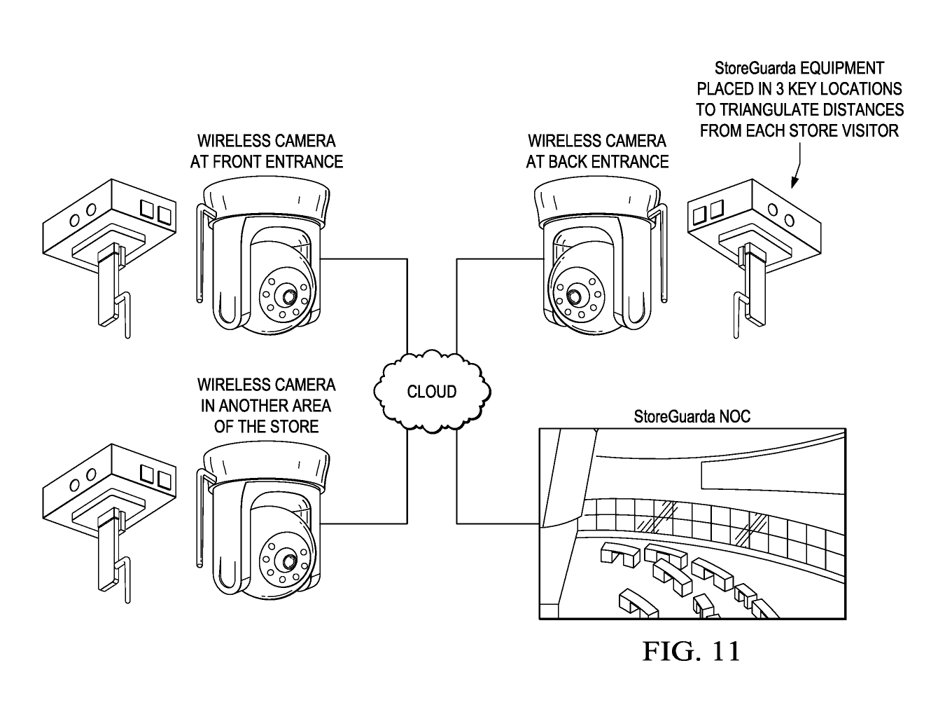

FIG. 11 depicts a network diagram for a store or bank branch deployment of a preferred embodiment. A minimum of three RCUs are preferred so as to triangulate the distance of each person from each of the RCUs and to thereby determine the exact relative location of each person and thereby able to display the MAC address associated with each person.

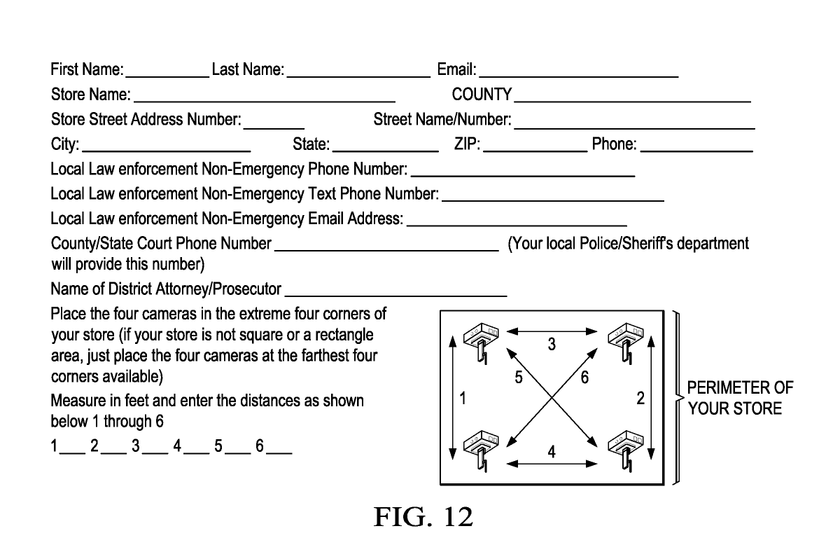

FIG. 12 depicts the Graphical User Interface for the Store/Bank owner/user to set up the preferred embodiment system. The Interface may be accessed either locally by the user or remotely, such as via an Internet connection to the RCU or to software locate either in part or whole on devices that communicate with the RCU, including items located at the Monitoring Call Center. In any event, through such an interface, a user or operate may further provide information required to report thieves and vandals to the local law enforcement and pursue the local jurisdiction court for the court order required for phone number, personal details and subsequent tracking. In a preferred embodiment, the user also is required to enter the dimensions of the area (i.e., Geo-Sphere Fence) being monitored.

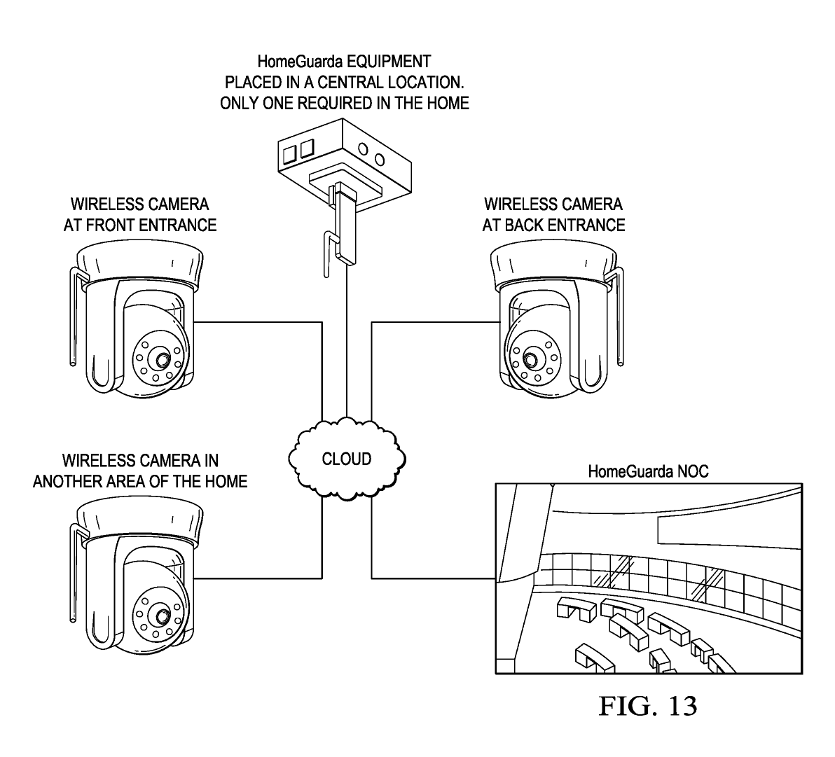

FIG. 13 depicts the Network Diagram at the home. A minimum of one camera and RCU is required, but preferably three cameras.

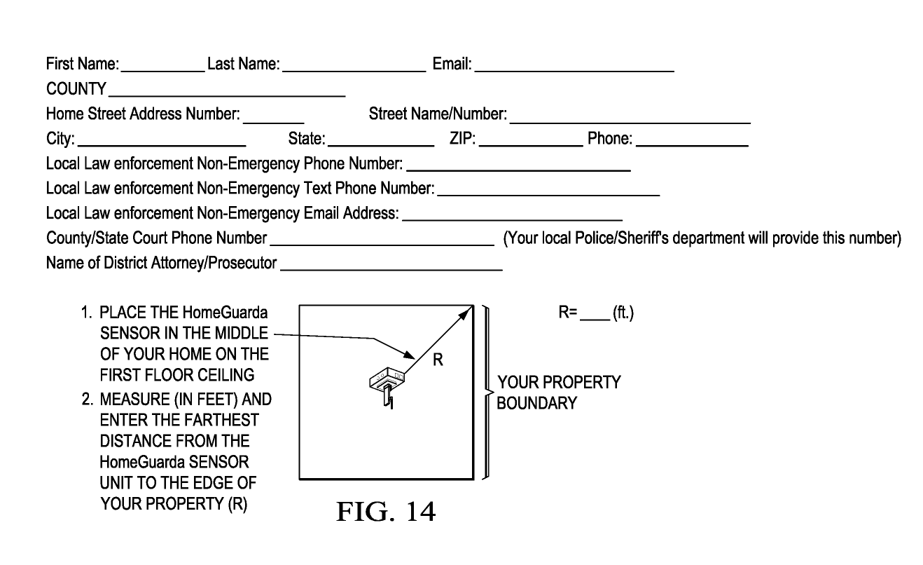

FIG. 14 depicts the Graphical User Interface, again accessible as with the Interface of FIG. 12. For FIG. 14, the Home owner/user, or an appropriate designee such as at the Monitoring Call Center, can set up the preferred embodiment system and provide the information required to report thieves and vandals to the local law enforcement and pursue the local jurisdiction court for the court order required for phone number, personal details and subsequent tracking. In a preferred embodiment, the user also is required to enter the radius of the area (i.e., Geo-Sphere Fence) being monitored from the center location of the property.

In all events, from the above, the preferred embodiments provide a capture and tracking system (e.g., via MAC address/GPS/image), allowing detection and potential identification of unauthorized persons, such as thieves and vandals at manned and un-manned sites. The principles of the preferred embodiments, therefore, may be applied to any site where theft or vandalism is a potential, from homes, jewelry stores, banks, to remote un-manned sites such as wireless cell towers, oil rigs, electric substations, etc. The preferred embodiments are therefore demonstrated above to have various apparatus, steps, and benefits, as will be appreciated by one skilled in the art. Further, while the inventive scope has been demonstrated by certain preferred embodiments, one skilled in the art will appreciate that it is further subject to various modifications, substitutions, or alterations, without departing from that inventive scope. For example, while certain apparatus and steps have been provided, alternatives or alternative ordering may be selected. Thus, the inventive scope is demonstrated by the teachings herein and is further guided by the following exemplary but non-exhaustive claims.

What is claimed is:

1. A system for monitoring an area, comprising:
detecting apparatus for detecting a presence signal of a portable phone associated with a person in the area;
capturing apparatus for capturing video in response to the detecting apparatus;
communication apparatus for communicating the captured video to a monitoring location remote from the area;
monitoring apparatus at the monitoring location for determining whether the person is authorized to be in the area.

2. The system of claim 1 wherein the monitoring apparatus comprises a call center for receiving a call from the person.

3. The system of claim 1 wherein the monitoring apparatus comprises a video display for displaying the captured video.

4. The system of claim 1 wherein the detecting apparatus comprises a wireless access point responsive to a MAC address signal of the portable phone.

5. The system of claim 1 and further comprising transmission apparatus for communicating an email from the area to the monitoring location in response to detecting the person in the area.

6. The system of claim 1 and further comprising transmission apparatus for communicating a text message from the area to the monitoring location in response to detecting the person in the area.

7. The system of claim 1 and further comprising apparatus for tracking a geographical position of the portable phone in response to the monitoring apparatus.

8. The system of claim 1:
wherein the detecting apparatus comprises a wireless access point responsive to a MAC address signal of the portable phone; and
further comprising apparatus for translating the MAC address to a phone number associated with the portable phone.

9. The system of claim 1 and further comprising apparatus for communicating information to law enforcement in response to the monitoring apparatus.

10. The system of claim 1 and further comprising circuitry for adjusting a distance that defines a size of the area.

11. The system of claim 10 and further comprising a single or dual antenna connected to the detecting apparatus and communication apparatus, the single antenna operable to receive the signal of a portable phone and to communicate the captured video.

12. The system of claim 11 wherein the single or dual antenna is further for communicating the captured video to a network.

13. The system of claim 1 wherein the monitoring apparatus comprises a list of persons authorized to be in the area.

14. The system of claim 13 wherein the list of persons is editable by a user of the system.

15. The system of claim 13 wherein the list of persons comprises a MAC address for each person in the list.

16. The system of claim 13 wherein the list of persons comprises image data for each person in the list.

17. A system for monitoring an area, comprising:
electromagnetic radiation detecting apparatus for detecting a person in the area;
capturing apparatus for capturing video in response to the detecting apparatus;
communication apparatus for communicating the captured video to a monitoring location remote from the area;
apparatus at the monitoring location for determining whether the person is authorized to be in the area; and
circuitry for adjusting a distance that defines a size of the area.

18. A system for monitoring an area, comprising:
electromagnetic radiation detecting apparatus for detecting a person in the area;
capturing apparatus for capturing video in response to the detecting apparatus;
communication apparatus for communicating the captured video to a monitoring location remote from the area; and
apparatus at the monitoring location for determining whether the person is authorized to be in the area.
